(19) United States
(12) Patent Application Publication
(10) Pub. No.: US 2025/0305077 A1
(43) Pub. Date: Oct. 2, 2025

(54) ULTRA-LARGE LINEAR ENERGY WELDING STEEL AND PREPARATION METHOD THEREFOR

(71) Applicants: ZHANGJIAGANG RONGSHENG SPECIAL STEEL CO. LTD., Suzhou, Jiangsu (CN); INSTITUTE OF RESEARCH OF IRON AND STEEL, JIANGSU PROVINCE/SHA-STEEL, CO. LTD (CN), Suzhou, Jiangsu (CN); JIANGSU SHAGANG GROUP CO., LTD., Suzhou, Jiangsu (CN)

(72) Inventors: Fu ZHAO, Suzhou (CN); Yu ZHANG, Suzhou (CN); Na WANG, Suzhou (CN)

(73) Assignees: ZHANGJIAGANG RONGSHENG SPECIAL STEEL CO. LTD., Suzhou, Jiangsu (CN); INSTITUTE OF RESEARCH OF IRON AND STEEL, JIANGSU PROVINCE/SHA-STEEL, CO. LTD (CN), Suzhou, Jiangsu (CN); JIANGSU SHAGANG GROUP CO., LTD., Suzhou, Jiangsu (CN)

(21) Appl. No.: 18/851,579

(22) PCT Filed: Mar. 31, 2023
(86) PCT No.: PCT/CN2023/085313

§ 371 Date: Sep. 26, 2024

(30) Foreign Application Priority Data
Mar. 13, 2023 (CN) 202310238411.3

(51) Int. Cl. C21D 9/00; C21D 6/00; C21D 8/02; C22C 38/00; C22C 38/02; C22C 38/48; C22C 38/50; C22C 38/58

(52) U.S. Cl. CPC C21D 9/0081; C21D 6/004; C21D 6/005; C21D 8/0205; C21D 8/0226; C22C 38/002; C22C 38/02; C22C 38/48; C22C 38/50; C22C 38/58

(57) ABSTRACT

A preparation method for ultra-high heat input welding steel, and prepared welding steel are provided. A steel plate oxide inclusion beneficial control is used, and low-temperature large-rolling-reduction rolling is also used. The size and distribution of an oxide in a steel plate are regulated and controlled by controlling a rolling process, thereby realizing the preparation of ultra-high heat input welding steel. The method has a low production cost, the production process is easy to control, the operation is simple, the method is suitable for large-scale production, and the mechanical properties and welding heat impact properties of the base material are excellent.

### CROSS-REFERENCE TO RELATED APPLICATIONS

The present application claims priority to Chinese Patent Application No. 202310238411.3, filed to the China Patent Office on Mar. 13, 2023 and entitled “Ultra-high Heat Input Welding Steel and Preparation Method therefor”, entire contents of which are incorporated herein by reference.

### TECHNICAL FIELD

The present application belongs to the technical field of steel rolling, and particularly relates to ultra-high heat input welding steel and a preparation method therefor.

### BACKGROUND

In the fields of ships, architectures, bridges and other large steel structures, welding is a key link of manufacturing, and increasing heat input may improve the welding efficiency, and shorten an engineering manufacturing cycle. Especially for thick steel plates, a conventional welding method requires multiple passes of welding molding, and requires tedious auxiliary work before welding and between layers as well, while adopting a high heat input welding method may achieve once pass molding, and the production efficiency is improved several times or dozens of times. Therefore, in each engineering field, the manufacturing of large steel welding structures tends to adopt the high heat input welding method to significantly reduce manufacturing costs and improve the production efficiency.

General high heat input welding steel may bear heat input between 100 KJ/cm and 400 kJ/cm, however, with the development of architectures, ships and other industries, further requirements are put forward for a higher heat input welding technology, and rolled steel is required to still have a high mechanical property at a 500-1500 KJ/cm ultra-high heat input, so as to ensure the safety and reliability of the engineering structure.

In the prior art, some ultra-high heat input welding high-strength steel and production methods are provided, however, a large amount of nickel elements or components with high prices such as calcium magnesium cored wires and zirconium calcium cored wires are mostly required to be added in a smelting process of rolled steel to improve low-temperature toughness of a welded joint under a high heat input welding condition, thereby greatly increasing the production cost. In addition, these technologies will improve the property of the rolled steel from the perspective of alloy compositions, it is difficult to control constituent contents on technological operation, the smelting process is prolonged, and the production efficiency is reduced.

It will have a wide application prospect in a case that a method for producing ultra-high heat input welding high-strength steel with high properties, without expensive components and with a shortened smelting process may be provided.

### SUMMARY OF THE INVENTION

Therefore, the present application aims to solve the technical problem that defects such as high production cost, large control difficulty, and low production efficiency of ultra-high heat input welding steel in the prior art are overcome, so as to provide ultra-high heat input welding steel and a preparation method therefor.

Thus, the present application provides the following technical solutions:

The present application provides a method for preparing ultra-high heat input welding steel, including the following steps:
a steelmaking step: casting into a slab after converter smelting and LF furnace refining;
a rolling step: heating the slab, two-stage rolling being adopted, wherein first-stage rolling is recrystallization zone rolling, a rolling temperature is in a range from 900° C. to 1000° C., and a single pass reduction rate is greater than 20%; performing temperature-holding on a steel plate, and performing second-stage rolling when the temperature drops to 800° C. or below, wherein the second-stage rolling is non-recrystallization zone rolling, and an adopted single pass reduction rate is greater than 20%; and controlling a total compression ratio in the rolling step to be 5 or above, wherein a compression ratio of the second-stage rolling accounts for 65-75% of the total compression ratio; and
a cooling step: performing cooling after the rolling step is completed.

Optionally, a finish rolling temperature of the first-stage rolling is in a range from 900° C. to 950° C.;
and/or, the finish rolling temperature of the rolling step is controlled within a range from 20° C. to 50° C. above a starting temperature Ar₃ of ferritic transformation.

Optionally, the single pass reduction rate in the first-stage rolling process is in a range from 21% to 23%;
and/or, the single pass reduction rate in the second-stage rolling process is in a range from 21% to 26%.

Optionally, a heating temperature of the slab is in a range from 1050° C. to 1150° C., and heating time of the slab is 330 min or above; and optionally, the heating time of the slab is in a range from 330 min to 350 min.

Optionally, a cooling speed in the cooling step is 11° C./s or above, and a finish cooling temperature is controlled within a range from 20° C. to 40° C. above a starting temperature Bₛ of bainite transformation, and then is reduced to 350° C. or below through air-cooling.

Ar₃=910-310C-80Mn-20Cu-15Cr-55Ni-80Mo-0.35(H-8), H is a target steel plate thickness, a unit is mm, and Bₛ=630-45Mn-40V-35Si-30Cr-25Mo-20Ni-15 W.

Optionally, in a converter smelting step, a ratio of a molten iron content to clean scrap steel is (7-8):1, and a molten iron temperature is in a range from 1350° C. to 1450° C.

Optionally, in a casting step, a casting temperature is controlled at a range from 1540° C. to 1560° C., and a casting speed is controlled at a range from 1.1 m/min to 1.3 m/min.

Optionally, it is characterized in that in percentage by weight, chemical components of the slab include: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

The action and dosage selection of components contained in the present application are specifically described below:
S: as a main element generating hot shortness in a hot rolling process, should be controlled within a reasonable range; and S is combined with Mn in steel to form MnS inclusions, especially when an Mn content in the steel is high, the formed MnS is not only numerous, but also huge in size, and in the hot rolling process, the plasticity of MnS makes MnS extend in a rolling direction, so as to form an MnS inclusion belt in the rolling direction, which seriously damages low-temperature impact toughness, ductility and Z-direction property of a steel plate.
Cr: being capable of effectively improving the hardenability of the steel plate, when the content is greater than 0.1%, combining with an ultra-rapid cooling technology, a structure based on fine acicular ferrite is formed, however, excessive content will also generate an adverse effect on a welding property of the steel plate.
Ni: an effective element for improving strength and low-temperature toughness; however, excessive Ni content will cause difficult removal of oxide skin of the steel plate, such that the surface quality of the steel plate is affected, and Ni is expensive, which will increase manufacturing costs after being excessively added.

The present application further provides ultra-high heat input welding steel, prepared by the above preparation method.

Optionally, according to the ultra-high heat input welding steel, a yield strength of a base material is 460 Mpa or above, a tensile strength is in a range from 560 Mpa to 620 Mpa, a ductility is 26% or above, and −40° C. impact energy is 280 J or above; and
optionally, under the condition of welding heat input being 600 KJ/cm, a tensile strength of a welding heat affected zone is 580 Mpa or above, and −40° C. impact energy is 220 J or above.

The technical solutions of the present application have the following advantages:

The method for preparing the ultra-high heat input welding steel provided by the present application includes the following steps: the steelmaking step: casting into the slab after converter smelting and LF furnace refining; the rolling stage: heating the slab, two-stage rolling being adopted, wherein the first-stage rolling is recrystallization zone rolling, the rolling temperature is in a range from 900° C. to 1000° C., and the single pass reduction rate is greater than 20%; performing temperature-holding on the steel plate, and performing second-stage rolling when the temperature drops to 800° C. or below, wherein the second-stage rolling is non-recrystallization zone rolling, and the adopted single pass reduction rate is greater than 20%; controlling the total compression ratio in the rolling step to be 5 or above, wherein the compression ratio of the second-stage rolling accounts for 65-75% of the total compression ratio; and the cooling stage: performing cooling after rolling is completed. The present application breaks through a traditional idea of oxide metallurgy for the first time, adopts a low-temperature large reduction rolling technology to produce the ultra-high heat input welding steel, regulates and controls sizes and distribution of oxides in the steel plate by limiting the single pass reduction rate and the total compression ratio in the two-stage rolling, and the compression ratio in the second-stage rolling and combining with a TMCP technology, and solves the problem of controlling dense distribution of oxide inclusion particles in the steel plate, thereby preparing the ultra-high heat input welding steel. The method has the characteristics of low production cost, easily-controlled production process, simple operation, and suitability for scale production, meanwhile, the oxide content is not controlled by adding expensive components in the steelmaking stage, thus a rolling cycle is shortened, and the production efficiency is improved; and the method further has a high additional value, which is mainly reflected in an excellent mechanical property of the base material and an excellent welding heat affected zone property, especially under a welding condition of high heat input, low temperature toughness of the welding heat affected zone is stable, and the thus method may be widely applied to a variety of large and extra-large steel structures requiring efficient welding. From the point of view of downstream welding users, the present application further improves the welding efficiency, greatly reduces the welding labor strength, saves work welding costs of the users, greatly shortens time of the users for manufacturing steel members at the same time, and creates great value for the users.

According to the method for preparing the ultra-high heat input welding steel provided by the present application, the beneficial control technology for the oxide inclusions in the steel plate is invented, by increasing the rolling compression ratio and the single pass reduction rate, sizes of metallic oxide inclusions in the steel plate are controlled to be lower than valid grain sizes, and thus slight inclusions are fully dispersed and distributed, which promotes generation of intragranular acicular ferrite. In addition, the present application may further regulate and control the area density of oxides in the steel plate, the content and size of the acicular ferrite and the like through limitation of parameters, and then regulates and controls properties of the steel plate.

The ultra-high heat input welding steel provided by the present application is prepared by adopting the specific method of the present application. A percentage content ratio of the acicular ferrite in the prepared steel plate is 75% or above, the size of the acicular ferrite is 17 μm or below, the yield strength of the base material is 460 Mpa or above, the tensile strength is in a range from 560 Mpa to 620 Mpa, the ductility is 26% or above, and the −40° C. impact energy is 280 J or above; and under the condition of welding heat input being 600 KJ/cm, the tensile strength of the welding heat affected zone is 580 Mpa or above, and −40° C. impact energy is 220 J or above.

### DETAILED DESCRIPTION

Following examples are provided for better further understanding the present application, which is not limited to the preferable embodiment, and do not limit contents and the scope of protection of the present application. Any product identical or similar to the present application that is derived by any person as a result of the inspiration of the present application or by combining the present application with other features of the prior art falls within the scope of protection of the present application.

Specific experimental procedures or conditions not indicated in the examples may be performed in accordance with operations or conditions of conventional experimental procedures described in the literature in the field. Used reagents or instruments are all conventional reagent products that can be purchased through the market if not indicated with manufactures.

### Example and Comparative Example

A method for preparing ultra-high heat input welding steel includes the following steps:

### 1. Component Design and Steelmaking Technology

In percentage by weight, chemical components of a steel plate include: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

The steelmaking technology: a ratio of converter steelmaking molten iron content to clean scrap steel is (7-8):1, a molten iron temperature is in a range from 1350° C. to 1450° C., and ferromanganese, ferrosilicon and lime are sequentially added for smelting. LF refining is mainly to control inclusions and regulate alloy components, manganese metal, ferrosilicon and the like are added to regulate components of molten steel, temperature measurement and sampling are performed after being electrified, then continuous deoxidation by diffusion and temperature regulation are performed, and finally, sampling, oxide-stabilizing and steel tapping are performed. A casting temperature is controlled at a range from 1540° C. to 1560° C., a casting speed is controlled at a range from 1.1 m/min to 1.3 m/min, and then a continuous cast slab is prepared.

### 2. Rolling Technology

1) the slab is heated, a heating temperature is controlled in a range from 1050° C. to 1150° C., and heating time is controlled at a range from 330 min to 350 min.
2) the slab is rolled, two-stage control rolling is adopted, first-stage rolling is recrystallization zone rolling, a rolling temperature is controlled to be above a recrystallization critical temperature, the range is in a range from 900° C. to 1000° C., a single pass reduction rate is greater than 20%, then temperature-holding is performed on the steel plate, second-stage rolling is performed when the temperature drops to 800° C. or below, the second-stage rolling is non-recrystallization zone rolling, an adopted single pass reduction rate is greater than 20%, and a finish rolling temperature is controlled within a range from 20° C. to 50° C. above Ar₃.

### 3. Cooling Technology

After rolling is completed, the steel plate is immediately transported to accelerated cooling control equipment (ACC) with a largest transport speed of a roller way, a cooling speed is required to be 11° C./s or above, a finish cooling temperature is controlled within a range from 20° C. to 40° C. above Bₛ, and then the steel plate is naturally air cooled to be 350° C. or below.

Specific control of components and parameters in each example and comparative example is as follows:

TABLE 1
Chemical components

| | Chemical components (wt %) | | | | | | | | | |
|---|---|---|---|---|---|---|---|---|---|---|
| | C | Si | Mn | P | S | Cr | Ni | Nb | Ti | Ca |
| Example 1 | 0.08 | 0.15 | 1.55 | 0.008 | 0.006 | 0.15 | 0.35 | \ | 0.030 | 0.0015 |
| Example 2 | 0.07 | 0.15 | 1.60 | 0.007 | 0.007 | 0.20 | 0.40 | \ | 0.030 | 0.0015 |
| Example 3 | 0.08 | 0.10 | 1.55 | 0.008 | 0.005 | 0.15 | 0.35 | \ | 0.030 | 0.002 |
| Example 4 | 0.08 | 0.15 | 1.55 | 0.008 | 0.006 | 0.15 | 0.35 | \ | 0.030 | 0.0015 |
| Example 5 | 0.07 | 0.15 | 1.60 | 0.007 | 0.005 | 0.20 | 0.40 | \ | 0.030 | 0.0015 |
| Example 6 | 0.08 | 0.10 | 1.55 | 0.008 | 0.006 | 0.15 | 0.35 | \ | 0.030 | 0.002 |
| Comparative | 0.08 | 0.10 | 1.55 | 0.008 | 0.006 | 0.15 | 0.35 | \ | 0.030 | 0.002 |
| example 1 | | | | | | | | | | |
| Comparative | 0.08 | 0.15 | 1.55 | 0.008 | 0.006 | 0.15 | 0.35 | \ | 0.030 | 0.0015 |
| example 2 | | | | | | | | | | |
| Comparative | 0.05 | 0.20 | 1.55 | 0.008 | 0.005 | 0.17 | 0.35 | \ | 0.030 | 0.0015 |
| example 3 | | | | | | | | | | |
| Comparative | 0.06 | 0.20 | 1.55 | 0.008 | 0.005 | 0.17 | 0.35 | \ | 0.030 | 0.0015 |
| example 4 | | | | | | | | | | |
| Comparative | 0.08 | 0.10 | 1.55 | 0.008 | 0.006 | 0.15 | 0.35 | \ | 0.030 | 0.002 |
| example 5 | | | | | | | | | | |
| Comparative | 0.08 | 0.10 | 1.55 | 0.008 | 0.006 | 0.15 | 0.35 | \ | 0.030 | 0.002 |
| example 6 | | | | | | | | | | |

TABLE 2
Steelmaking technology

| | Molten | | | |
|---|---|---|---|---|
| | iron:scrap | Molten iron | Casting | Casting |
| | steel | temperature | temperature | speed |
| Example 1 | 7:1 | 1350-1450° C. | 1540-1560° C. | 1.2 m/min |
| Example 2 | 7:1 | 1350-1450° C. | 1540-1560° C. | 1.2 m/min |
| Example 3 | 7:1 | 1350-1450° C. | 1540-1560° C. | 1.2 m/min |
| Example 4 | 7:1 | 1350-1450° C. | 1540-1560° C. | 1.2 m/min |
| Example 5 | 7:1 | 1350-1450° C. | 1540-1560° C. | 1.2 m/min |
| Example 6 | 7:1 | 1350-1450° C. | 1540-1560° C. | 1.2 m/min |
| Comparative | 7:1 | 1350-1450° C. | 1540-1560° C. | 1.2 m/min |
| example 1 | | | | |
| Comparative | 7:1 | 1350-1450° C. | 1540-1560° C. | 1.2 m/min |
| example 2 | | | | |
| Comparative | 7:1 | 1350-1450° C. | 1540-1560° C. | 1.2 m/min |
| example 3 | | | | |
| Comparative | 7:1 | 1350-1450° C. | 1540-1560° C. | 1.2 m/min |
| example 4 | | | | |
| Comparative | 7:1 | 1350-1450° C. | 1540-1560° C. | 1.2 m/min |
| example 5 | | | | |
| Comparative | 7:1 | 1350-1450° C. | 1540-1560° C. | 1.2 m/min |
| example 6 | | | | |

TABLE 3
Rolled steel heating and cooling technologies

| | | | | Finish |
|---|---|---|---|---|
| | Slab heating | Heating | Cooling | cooling |
| | temperature | time | speed | temperature |
| Example 1 | 1150° C. | 330 min | 11.5° C./s | 570° C. |
| Example 2 | 1150° C. | 335 min | 11.3° C./s | 573° C. |
| Example 3 | 1150° C. | 332 min | 11.2° C./s | 576° C. |
| Example 4 | 1150° C. | 330 min | 11.5° C./s | 570° C. |
| Example 5 | 1150° C. | 335 min | 11.3° C./s | 572° C. |
| Example 6 | 1150° C. | 332 min | 11.2° C./s | 575° C. |
| Comparative | 1150° C. | 332 min | 11.2° C./s | 576° C. |
| example 1 | | | | |
| Comparative | 1150° C. | 330 min | 11.5° C./s | 570° C. |
| example 2 | | | | |
| Comparative | 1150° C. | 332 min | 11.2° C./s | 583° C. |
| example 3 | | | | |
| Comparative | 1150° C. | 330 min | 11.3° C./s | 580° C. |
| example 4 | | | | |
| Comparative | 1150° C. | 332 min | 11.2° C./s | 575° C. |
| example 5 | | | | |
| Comparative | 1150° C. | 332 min | 11.2° C./s | 575° C. |
| example 6 | | | | |

TABLE 4
Rolling technology

| | | | | Non- | | Non- | | |
|---|---|---|---|---|---|---|---|---|
| | Recrystallization | Single | Recrystallization | recrystallization | Single | recrystallization | | Second- |
| | zone start | pass | zone finish | zone starting | pass | zone finish | Total | stage |
| | rolling | reduction | rolling | rolling | reduction | rolling | compression | compression |
| | temperature° C. | rate | temperature° C. | temperature | rate | temperature | ratio | ratio |
| Example 1 | 950 | 21%-23% | 910 | 770 | 21%-26% | 750 | 6 | 4 |
| Example 2 | 960 | 21%-23% | 920 | 765 | 21%-26% | 745 | 6 | 4 |
| Example 3 | 950 | 21%-23% | 910 | 770 | 21%-26% | 750 | 6 | 4 |
| Example 4 | 950 | 21%-23% | 910 | 770 | 21%-26% | 750 | 7 | 5 |
| Example 5 | 960 | 21%-23% | 920 | 765 | 21%-26% | 745 | 7 | 5 |
| Example 6 | 950 | 21%-23% | 910 | 770 | 21%-26% | 750 | 7 | 5 |
| Comparative | 950 | 15%-20% | 910 | 770 | 10%-15% | 750 | 5 | 3 |
| example 1 | | | | | | | | |
| Comparative | 950 | 15%-20% | 910 | 770 | 10%-15% | 750 | 5 | 3 |
| example 2 | | | | | | | | |
| Comparative | 950 | 15%-20% | 920 | 805 | 10%-15% | 786 | 5 | 3 |
| example 3 | | | | | | | | |
| Comparative | 950 | 15%-20% | 925 | 803 | 10%-15% | 785 | 5 | 3 |
| example 4 | | | | | | | | |
| Comparative | 950 | 21%-23% | 910 | 770 | 21%-26% | 750 | 4 | 2 |
| example 5 | | | | | | | | |
| Comparative | 950 | 15%-20% | 910 | 770 | 15%-20% | 750 | 7 | 5 |
| example 6 | | | | | | | | |

Note:
Ar₃ = 910-310C—80Mn—20Cu—15Cr—55Ni—80Mo—0.35(H-8), H is a target steel plate thickness, and each steel plate thickness is 50 mm; and Bₛ = 630—45Mn—40V—35Si—30Cr—25Mo—20Ni—15W.

TABLE 5
Base material property of steel plate and welded joint property

| | | | | | | Welded joint property | | |
|---|---|---|---|---|---|---|---|---|
| | | Base material property | | | | | | CGHAZ |
| | | Yield | Tensile | | −40° C. | Welding | Tensile | −40° C. |
| | Type of | strength | strength | | impact | heat input | strength | impact |
| | steel | MPa | MPa | Ductility % | energy J | kJ/cm | MPa | energy J |
| Example 1 | EH40 | 463 | 561 | 27 | 306, 301, 298 | 500 | 563 | 233, 225, 239 |
| Example 2 | EH40 | 475 | 580 | 26 | 316, 285, 301 | 500 | 575 | 235, 236, 245 |
| Example 3 | EH40 | 464 | 583 | 26 | 287, 298, 306 | 500 | 571 | 226, 241, 233 |
| Example 4 | EH40 | 473 | 591 | 28 | 316, 321, 308 | 600 | 583 | 233, 225, 239 |
| Example 5 | EH40 | 495 | 610 | 26 | 336, 325, 331 | 600 | 595 | 235, 236, 245 |
| Example 6 | EH40 | 484 | 603 | 27 | 307, 328, 326 | 600 | 591 | 226, 241, 233 |
| Comparative | EH40 | 433 | 554 | 25 | 241, 230, 221 | 400 | 521 | 124, 136, 115 |
| example 1 | | | | | | | | |
| Comparative | EH40 | 418 | 548 | 24 | 222, 218, 247 | 400 | 534 | 154, 164, 138 |
| example 2 | | | | | | | | |
| Comparative | EH40 | 423 | 547 | 24 | 191, 180, 198 | 400 | 530 | 85, 64, 67 |
| example 3 | | | | | | | | |
| Comparative | EH40 | 435 | 539 | 25 | 202, 188, 197 | 400 | 528 | 76, 74, 69 |
| example 4 | | | | | | | | |
| Comparative | EH40 | 431 | 544 | 24 | 223, 201, 230 | 400 | 523 | 134, 125, 140 |
| example 5 | | | | | | | | |
| Comparative | EH40 | 424 | 551 | 25 | 201, 220, 211 | 400 | 538 | 111, 130, 132 |
| example 6 | | | | | | | | |

TABLE 6
Steel plate physical property

| | | | Area |
|---|---|---|---|
| | | Acicular | density of |
| | Ferrite | ferrite | oxides in |
| | ratio, % | size, μm | steel plate |
| Example 1 | 76 | 17 | 1230 |
| Example 2 | 77 | 16 | 1250 |
| Example 3 | 76 | 17 | 1230 |
| Example 4 | 82 | 14 | 1450 |
| Example 5 | 83 | 12 | 1480 |
| Example 6 | 83 | 12 | 1470 |
| Comparative | 63 | 23 | 950 |
| example 1 | | | |
| Comparative | 62 | 23 | 940 |
| example 2 | | | |
| Comparative | 60 | 25 | 920 |
| example 3 | | | |
| Comparative | 60 | 25 | 930 |
| example 4 | | | |
| Comparative | 65 | 22 | 970 |
| example 5 | | | |
| Comparative | 64 | 23 | 960 |
| example 6 | | | |

Obviously, the above examples are only intended to clearly illustrate the given instances, but do not limit embodiments. For those of ordinary skill in the art, other variations or changes in different forms may further be made on the basis of the above illustration. It is not necessary or possible to exhaust all embodiments herein. Obvious variations or changes derived therefrom still remain within the scope of protection of the present application.

1. A method for preparing ultra-high heat input welding steel, comprising the following steps:
a steelmaking step: casting into a slab after converter smelting and LF furnace refining;
a rolling step: heating the slab, two-stage rolling being adopted, wherein first-stage rolling is recrystallization zone rolling, a rolling temperature is in a range from 900° C. to 1000° C., and a single pass reduction rate is greater than 20%; performing temperature-holding on a steel plate, and performing second-stage rolling when the temperature drops to 800° C. or below, wherein the second-stage rolling is non-recrystallization zone rolling, and an adopted single pass reduction rate is greater than 20%; and controlling a total compression ratio in the rolling step to be 5 or above, wherein a compression ratio of the second-stage rolling accounts for 65-75% of the total compression ratio; and
a cooling step: performing cooling after the rolling step is completed.

2. The method for preparing ultra-high heat input welding steel according to claim 1,
wherein a finish rolling temperature of the first-stage rolling is in a range from 900° C. to 950° C.;
and/or, the finish rolling temperature of the rolling step is controlled within a range from 20° C. to 50° C. above a starting temperature Ar₃ of ferritic transformation.

3. The method for preparing ultra-high heat input welding steel according to claim 2, wherein Ar₃-910-310C-80Mn-20Cu-15Cr-55Ni-80Mo-0.35(H-8), a unit of Ar₃ is ° C., H is a target steel plate thickness, and a unit is mm.

4. The method for preparing ultra-high heat input welding steel according to claim 1,
wherein the single pass reduction rate in the first-stage rolling process is in a range from 21% to 23%;
and/or, the single pass reduction rate in the second-stage rolling process is in a range from 21% to 26%.

5. The method for preparing ultra-high heat input welding steel according to claim 1, wherein a heating temperature of the slab is in a range from 1050° C. to 1150° C., and heating time of the slab is 330 min or above.

6. The method for preparing ultra-high heat input welding steel according to claim 5, wherein the heating time of the slab is in a range from 330 min to 350 min.

7. The method for preparing ultra-high heat input welding steel according to claim 1, wherein a cooling speed in the cooling step is 11° C./s or above, and a finish cooling temperature is controlled within a range from 20° C. to 40° C. above a starting temperature Bₛ of bainite transformation, and then is reduced to 350° C. or below through air-cooling.

8. The method for preparing ultra-high heat input welding steel according to claim 7, wherein Bₛ=630-45Mn-40V-35Si-30Cr-25Mo-20Ni-15 W, and a unit of Bₛ is ° C.

9. The method for preparing ultra-high heat input welding steel according to claim 1, wherein in a converter smelting step, a ratio of a molten iron content to clean scrap steel is (7-8):1, and a molten iron temperature is in a range from 1350° C. to 1450° C.

10. The method for preparing the ultra-high heat input welding steel according to claim 1, wherein in a casting step, a casting temperature is controlled at a range from 1540° C. to 1560° C., and a casting speed is controlled at a range from 1.1 m/min to 1.3 m/min.

11. The method for preparing ultra-high heat input welding steel according to claim 1, wherein, in percentage by weight, chemical components of the slab comprise: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

12. Ultra-high heat input welding steel, wherein the ultra-high heat input welding steel is prepared by the method according to claim 1.

13. The ultra-high heat input welding steel according to claim 12, wherein a yield strength of a base material is 460 Mpa or above, a tensile strength is in a range from 560 Mpa to 620 Mpa, a ductility is 26% or above, and −40° C. impact energy is 280 J or above.

14. The ultra-high heat input welding steel according to claim 13, wherein under the condition of welding heat input being 600 kJ/cm, a tensile strength of a welding heat affected zone is 580 Mpa or above, and −40° C. impact energy is 220 J or above.

15. The method for preparing ultra-high heat input welding steel according to claim 2, wherein, in percentage by weight, chemical components of the slab comprise: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

16. The method for preparing ultra-high heat input welding steel according to claim 3, wherein, in percentage by weight, chemical components of the slab comprise: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

17. The method for preparing ultra-high heat input welding steel according to claim 4, wherein, in percentage by weight, chemical components of the slab comprise: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

18. The method for preparing ultra-high heat input welding steel according to claim 5, wherein, in percentage by weight, chemical components of the slab comprise: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

19. The method for preparing ultra-high heat input welding steel according to claim 6, wherein, in percentage by weight, chemical components of the slab comprise: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.

20. The method for preparing ultra-high heat input welding steel according to claim 7, wherein, in percentage by weight, chemical components of the slab comprise: C: 0.05-0.16%, Si: 0.1-0.4%, Mn: 0.9-1.6%, P≤0.01%, S: 0.003-0.02%, Cr: 0.05-0.20%, Ni: 0.1-0.4%, Ti: 0.02-0.04%, Ca: 0.001-0.0025%, and the balance Fe and inevitable impurities.
